(19) United States
(12) Patent Application Publication
(10) Pub. No.: US 2006/0198859 A1
(43) Pub. Date: Sep. 7, 2006

(54) Compositions with a depot effect for controlling microorganisms

(75) Inventors: Petra Allef, Essen (DE); Stefan Bergfried, Essen (DE); Burghard Gruning, Essen (DE); Christian Weitemeyer, Essen (DE)

Correspondence Address: Scully, Scott, Murphey & Presser, Suite 300, 400 Garden City Plaza, Garden City, NY, 11530, US

(73) Assignee: Goldschmidt GmbH, Essen (DE)

(21) Appl. No.: 11/234,734

(22) Filed: Sep. 23, 2005

(30) Foreign Application Priority Data
Sep. 25, 2004 (DE) DE 102004046603.3

(51) Int. Cl. A01N 25/00; A01N 37/06

(52) U.S. Cl. 424/405; 514/547

(57) ABSTRACT

The invention relates to compositions for controlling microorganisms comprising an effective content of mixtures of fatty acid esters of a polyol and of short-chain monocarboxylic acids and/or salts thereof.

### FIELD OF THE INVENTION

The present invention relates to compositions with a depot effect for controlling microorganisms, and more particular to compositions that comprise an effective content of esters of a polyol and of salts of short-chain fatty acids.

### BACKGROUND OF THE INVENTION

A large number of antimicrobially effective chemical substances and mixtures of these substances are known for controlling microorganisms (Gram-positive bacteria, Gram-negative bacteria, mycobacteria, dermatophytes, yeast and hyphal fungi, viruses and spores) which are present on the surface of the skin and hair, clothing, devices for body cleansing and body care, such as, for example, in the dental sector, medical instruments, but also rooms and fitments These substances and mixtures are divided according to their intended use into disinfectants, preservatives, antiseptics and cosmetic active ingredients, to name but a few.

The main representatives of these groups are: aldehydes, such as formaldehyde, glyoxal or glutaraldehyde; phenol derivatives, such as 2,2′-dihydroxybiphenyl and 4-chloro-3-methylphenol; quaternary ammonium compounds, cationic surfactants, such as benzalkonium chloride, cetrimonium bromide, cetylpyridinium chloride; amphoteric surfactants, and also compounds which release active oxygen, such as, for example, hydrogen peroxide, organic peracids, alkyl peroxides or alkyl hydroperoxides.

However, these compounds have a number of disadvantages since they do not meet, or only meet inadequately, the diverse requirements which are placed on them in practice, such as, for example, broad activity spectrum, short action times at low temperatures, good skin compatibility, low toxicity, and material compatibility.

Aldehyde- or phenol-based disinfectants are regarded as being toxicologically and ecologically unacceptable. These disinfectants often lead to sensitizations, in particular of the skin and respiratory organs, and moreover have a characteristic, pungent and unpleasant odor. Some are also potential carcinogens.

Quaternary ammonium compounds (e.g., quats) are for the most part toxicologically acceptable, have no or only very low skin sensitization and are virtually odorless. However, they have a considerable skin-irritative effect. As with the use of aldehydes, the use of quats may lead to undesired deposits and films on the surfaces treated; these are optically disadvantageous and can only be removed by customary cleansing processes with difficult, if at all.

DE-A-42 37 081 discloses cosmetic deodorants which comprise, as active ingredients, fatty acid esters of di- and triglycerol. According to the teaching therein, only the monoesters are effective for controlling Gram-positive bacteria.

These monoesters can be prepared according to the known chemical processes of the prior art (DE-A-38 18 293) by alkali-catalyzed reaction of a 1.5- to 2.5-fold molar excess of fatty acids or fatty acid derivatives with isopropylidene derivatives of di- and triglycerol, subsequent purification of the reaction product and subsequent acidic hydrolysis or alcoholysis of the isopropylidene groups.

In addition, enzymatically catalyzed processes for the preparation of polyglycerol fatty acid esters are also known. In this connection, D. Charlemagne and M. D. Legoy (JAOCS 1995, Vol. 72, No. 1, 61-65) adsorb firstly the polyglycerol to the same amount of silica gel before allowing it to react in suspension with fatty acid methyl esters with lipase catalysis. The main disadvantage here is the loss of the expensive enzyme which is separated off together with the silica gel by filtration when the reaction is complete. S. Matsumura, M. Maki, K. Toshima and K. Kawada (J. Jpn. Oil Chem. Soc. 1999, Vol. 48, No. 7, 681-692) utilize a modification of this process in order to synthesize polyglycerol esters using 20% by weight of enzyme. According to the teaching conveyed in DE-A-42 37 081, they carry out further purification at high expenditure by means of column chromatography in order to obtain pure monoesters with the known antimicrobial activities.

EP-B-1 250 842 discloses mixtures of fatty acid mono-, di- and triesters of polyglycerol prepared by enzymatically catalyzed reaction. These are said to have comparable and, in some cases, even considerably better activities when controlling microorganisms than the monoesters prepared by chemical synthesis or enzymatic preparation and purification.

### SUMMARY OF THE INVENTION

It is therefore an object of the present invention to provide compositions for controlling microorganisms which largely remedy the described disadvantages of the prior art compositions, display high antimicrobial action and can be prepared in an uncomplicated manner from readily accessible raw materials by an economically feasible and ecologically acceptable process.

Surprisingly, it has been found that the antimicrobial effect of the polyol esters known from the prior art is significantly surpassed by mixtures of short-chain fatty acids or salts thereof and the polyol esters and thus improved antimicrobial compositions can be provided. Without wishing to limit the invention to one mechanism or theory, the effect of the polyol esters can be attributed essentially to the cleavage of the esters by the enzymes present on the skin. The fact that cleavage of the esters only takes place to an adequate extent if sufficient microorganisms are present leads to the effect of the deodorant formulations prepared with polyol esters often starting too late to completely prevent the formation of troublesome body odors. For this reason, further antimicrobial active ingredients were necessary as additive.

The present invention therefore provides antimicrobially effective compositions for controlling microorganisms which have an effective content of mixtures of fatty acid mono- and diesters of polyols, preferably esters of polyglycerol, in particular of mono-, di- and/or triglycerol with C₆₋₁₄ monocarboxylic acids and of short-chain, saturated or unsaturated, optionally branched, optionally hydroxy-substituted monocarboxylic acids, in particular C₃₋₁₄ fatty acids and in particular salts thereof.

However, the use of short-chain fatty acids on their own is not very desirable since these have an unpleasant odor and irritate the skin in relatively high doses. Furthermore, they are rapidly metabolized on the skin and thus offer no long-term protection. (Kabara J J. Fatty acids and derivatives as antimicrobial agents. In: Kabara J J, ed. The Pharmacological Effect of Lipids I. Champaign, IL: American Oil Chemists' Society; 1978; 1-14. Wyss O, Ludwig B J, Joiner R R. The fungistatic and fungicidal action of fatty acids and related compounds. Arch Biochem. 1943; 7, 415.)

The invention further provides the use of these antimicrobially effective mixtures for producing disinfectants, sterilizing compositions, antiseptics, preservatives which are suitable for the sterilization and disinfection of surfaces and surgical instruments, and for preservation, in particular for the preservation of cosmetic or dermatological preparations.

Moreover, the compositions are also suitable for the preservation of foods and can also be used for the antimicrobial finishing of food packagings. The antimicrobial compositions according to the present invention are particularly suitable, partly due to their mildness, for producing cosmetic preparations for controlling body odor, for controlling dandruff and for controlling blemished skin and for controlling caries.

### BRIEF DESCRIPTION OF THE DRAWINGS

FIGS. 1A-1J are graphs of Colony Count (CFU/ml) vs. Time (h) for various substances.

FIG. 2 is a graph illustrating order reduction of various substances.

### DETAILED DESCRIPTION OF THE INVENTION

As stated above, the present invention provides compositions with a depot effect for controlling microorganisms. Specifically, the compositions of the present invention include an effective amount of esters of polyol and short chain fatty acids. The components of the inventive compositions will now be described in greater detail.

Examples of the polyols used according to the present invention are ethylene glycol, propylene glycol, butylene glycol, pentanediol, hexanediol, in particular the 1,2-regioisomers thereof, trimethylolpropane, glycerol and carbohydrates, such as, for example, sorbitol or glucose, and polymers of said polyols. Preference is given in the present invention to polyglycerols with the general formula
HO—CH₂—CH(OH)—CH₂—O—[CH₂—CH(OH)—CH₂—O]ₙ—H
in which n=0 to 9, preferably 1 to 6, in particular 1 to 3, specifically 1 and 2. Moreover, the polyglycerols used in the present invention can also be branched and contain cyclic fractions.

The polyglycerols are liquids which are highly viscous at room temperature and which, besides diglycerol, primarily comprise the more highly condensed oligomers of glycerol. For the purposes of the present invention, preference is given to using technical-grade mixtures of polyglycerols which usually comprise diglycerol, triglycerol, tetraglycerol and pentaglycerol.

The polyglycerols can, for example, be prepared industrially by base-catalytic condensation of glycerol or else by hydrolysis and condensation of epichlorohydrin. Moreover, polyglycerols are also accessible by polymerization of glycidol. Separation and isolation of the individual polyglycerols is possible by treatment with the various agents known in the prior art. An overview by G. Jakobson of the various synthetic routes can be found in “Fette Seifen Anstrichmittel”, 1986, volume 88, No. 3, 101-106. The various structural possibilities for polyglycerol can be checked in H. Dolhaine, W. Preuβ and K. Wollmann (Fette Seifen Anstrichmittel 1984, volume 86, No. 9, 339-343).

Standard commercial products are generally mixtures of polyglycerols with varying degrees of condensation, the maximum degree of condensation can generally be up to 10, and in exceptional cases may also be greater. Particular preference is given to using polyglycerols which comprise only, or predominantly di- and triglycerol.

The fatty acids and fatty acid derivatives, and mixtures thereof, to be used with preference for the purposes of the present invention for the ester formation are derived from straight-chain or branched, saturated, mono- or polyunsaturated carboxylic and fatty acid esters having 6 to 14 carbon atoms, preferably 8 to 12, in particular 8 to 10, carbon atoms in the main chain.

The fatty acid derivatives which may be used in the present invention are all customary derivatives which take part in (trans)esterification reactions. According to the invention, the fatty acid derivatives are particularly chosen from fatty acid alkyl esters having 1 to 4 carbon atoms in the alcohol radical.

The fatty acids or esters thereof used are, individually or in mixtures, fatty acids, such as caproic acid, caprylic acid, capric acid, 2-ethylhexanoic acid, undecylenic acid, lauric acid and myristic acid. In principle, all fatty acids with a similar chain distribution are suitable.

Preference is given to using caprylic acid and capric acid.

The esters are prepared by a chemical or enzymatic process known in the prior art, see, for example, DE-B-42 37 081, EP-B-1 250 842 or EP-B-0 451 461.

The polyol fatty acid esters according to this invention consist, in summary, of a mixture of compounds of varying degree of esterification which can comprise considerable fractions of nonesterified polyol. The parent polyol can be uniform or, a mixture of products of varying degree of condensation.

A further essential constituent of the mixtures according to the present invention is salts of straight-chain or branched monocarboxylic acids having 3 to 14 carbon atoms in the main chain and optionally containing OH groups and/or double bonds. Examples are lactic acid, caproic acid, lauric acid, 2,4-hexadienoic acid, in particular caprylic acid and capric acid. Under the physiological conditions of the skin, these salts are immediately and adequately effective until the onset of the deodorizing effect from the depot of the esters.

These salts may be alkali metal, alkaline earth metal and/or ammonium salts of the acids. To prepare clear solutions of the salts in the esters, preference is given according to the present invention to co-using alkali metal salts, in particular the potassium salts.

The mixing ratio of ester and salt is basically unimportant and can be varied over wide ranges. However, since a maximum depot effect with adequate immediate effect is desired, a fraction of from 1 to 20%, in particular 5 to 10%, of the salts is generally sufficient.

Moreover, the compositions according to the present invention for controlling microorganisms can, depending on the intended use, also comprise anionic, nonionic, cationic and/or amphoteric surfactants customary in this field.

Typical examples of such surfactants are:

1. nonionic surfactants based on alkylene oxides, such as ethoxylates of long-chain branched alcohols, ethoxylates of sorbitan esters, propylene oxide-ethylene oxide copolymers, hydroxyalkyl fatty acid amides, polydimethylsiloxane polyalkylene oxide copolymers, sugar-based surfactants, such as alkyl polyglycosides, alkyl glycoside esters, N-acylglucamides and polyglycerol esters,

2. anionic surfactants, such as alkyl sulfates and alkyl ether sulfate, α-olefinsulfonates, fatty acid ester sulfonates, alkylarylsulfonates, sulfosuccinates, alkyl or alkoxyalkyl phosphates, taurates, N-acylamino acid derivatives, sarcosinates, isethionates and soaps,

3. cationic surfactants, such as alkyltrimethylammonium salts, fatty acid esters of di- and triethanolammonium salts, alkylimidazolinium salts, acylamidopropyldimethylammonium salts, cationically derivatized polydimethylsiloxanes,

4. zwitterionic and amphoteric surfactants, such as betaines, sulfobetaines, amine oxides and amphoacetates.

The compositions according to the present invention for controlling microorganisms are, for example, sterilizing compositions, disinfectants, disinfectant cleaning compositions, all-purpose cleaners, sanitary cleaners, bath cleaners, machine dishwashing detergents, laundry detergents, cosmetic cleansers and care compositions. Cosmetic compositions based on the described polyol fatty acid esters are used, in particular in amounts of from 0.01 to 5% by weight, for controlling body odor, dandruff, skin blemishes or caries. They can be formulated as such in the form of homogeneous liquids, gels, ointments, pastes, wax-like or emulsion-like preparations. Use in the form of wet wipes is also possible. Particularly in the emulsion form, they comprise oils, such as ester oils, volatile or low-volatile silicone derivatives, such as decamethylcyclopentasiloxane, paraffin oils and the like.

In the case of applications of the mixtures according to the present invention, particularly in the pH range of <7, it is possible to dispense with the additional co-use of necessary antimicrobially effective substances usually used in the prior art for controlling microorganisms. This is, however, if desired, essentially possible without disadvantages.

As such, mention may be made of triclosan, farnesol, 2-ethylhexyloxyglycerol or octyl lactate. Depending on the intended use, besides the specified surfactants, they may also comprise the auxiliaries and additives specific in each case, for example, solvents, builders, foam inhibitors, salts, bleaches, bleach activators, optical brighteners, graying inhibitors, solubilizers, thickeners, fragrances and dyes, emulsifiers, biogenic active ingredients, such as plant extracts and vitamin complexes. Suitable solvents are, in particular, water or alcohols, such as, for example, ethanol, propanol, isopropanol, 2-methyl-2-propanol, propylene glycol, dipropylene glycol or glycerol.

The amounts of such additives to be used in each case are, depending on the nature of the particular product, known to a person skilled in the art or, where necessary, can be readily ascertained by simple experimentation.

Further possible uses for the compositions according to the present invention is their use as preservatives in foods and in food packagings, where they are usually used in concentrations of from 0.01 to 5% by weight, preferably 0.1 to 1% by weight. The esters according to the present invention can simply be added to foods in the corresponding amount. For use in packagings, the polyol esters are used, for example, by impregnating papers with a solution or emulsion of the esters, or by spraying films with corresponding preparations of the esters. The esters can also be added before or during the shaping process of the packagings, such as to the extrusion.

The mixtures according to the present invention are preferably prepared by esterifying the polyol with fatty acid, preferably in the molar ratio 1:1 with solvent under an inert atmosphere at temperatures of from 180 to 260° C. by processes known per se. At a fatty acid conversion degree of from 90 to 95%, the mixture is cooled to temperatures of preferably <100° C. and neutralized with a base, preferably the carbonates, in particular with potassium carbonate.

Likewise, the complete esterification in the first stage and the subsequent addition of the acids and their neutralization in the second stage, or the addition of the salts of the acids is possible.

The working examples below represent preferred reactions of the present invention, but are not suitable for limiting the invention thereto.

Microbiological Tests:

The effectiveness of the products according to the present invention is established using the challenge test (in accordance with the European Pharmaceuticals Directive). This shows that the products of the present invention are far superior compared with the prior art products.

Carryying out the Microbiological Tests:

A) Against Corynebacterium xerosis, Staphylococcus epidermidis and Candida albicans

1. Samples and Material:

1.1. Samples
a. Diglycerol caprylate
   (comparison substance according to the prior art)
b. Diglycerol caprylate with 5% potassium caprylate
c. Diglycerol caprylate with 10% potassium caprylate
d. Diglycerol caprylate with 15% potassium caprylate
e. Polyglycerol-3 caprylate
f. Polyglycerol-3 caprylate with 7% potassium caprylate
g. Triethylene glycol caprylate
h. Triethylene glycol caprylate with 5% potassium caprylate
i. Sorbitan caprylate
j. Sorbitan caprylate with 5% potassium caprylate

1.2 Test Microbes
Corynebacterium xerosis DSM 20743
Staphylococcus epidermidis DSM 3269
Candida albicans ATCC 10231

1.3 Media Used
Nutrient media:
CSL: casein peptone-soybean meal peptone solution
CSA: casein peptone-soybean meal peptone-agar
Sabouraud glucose broth/agar
Dilution liquid with inactivation additives
NaCl peptone buffer solution with inactivator (3% Tween® 80, 0.3% lecithin, 0.1% histidine, 0.5% Na thiosulfate)
   2. Method

2.1. Preparation of the Test Solutions

On the day before the investigation, test solutions of 0.1% (w/v) in CSL were prepared from each sample. To this, 100 ml of CSL were, in each case, heated to 60° C. in a water bath. From each sample, 0.1 g was weighed into 100 ml of CSL at 60° C. The preparations were shaken vigorously by hand and left overnight at 30° C. in an incubator.

2.2. Preparation of the Test Microbe Suspensions

Cultivate Corynebacterium xerosis over 3 to 4 days. Isolate other microbes in broth or by elutriation.

2.3. Contamination of the samples and determination of the reduction in the number of microbes

For each test microbe, 20 ml of each test solution were introduced into sterile 50 ml brown glass bottles with glass beads and contaminated with 0.2 ml of microbe suspension. As controls, 20 ml of CSL without sample were also prepared per test microbe. The contaminated samples were shaken for 3 min on a shaking machine and kept in an incubator at 30° C. until removed.

At the removal intervals (1, 2, 3, 24 and 48 hours), 1 ml was taken from each preparation and transferred to 9 ml of NaCl-peptone buffer solution with inactivator and the colony count was determined.

The 0 hour values given were the colony counts of the test microbe suspension used taking into consideration the 10⁻² dilution upon sample contamination.

3. Results

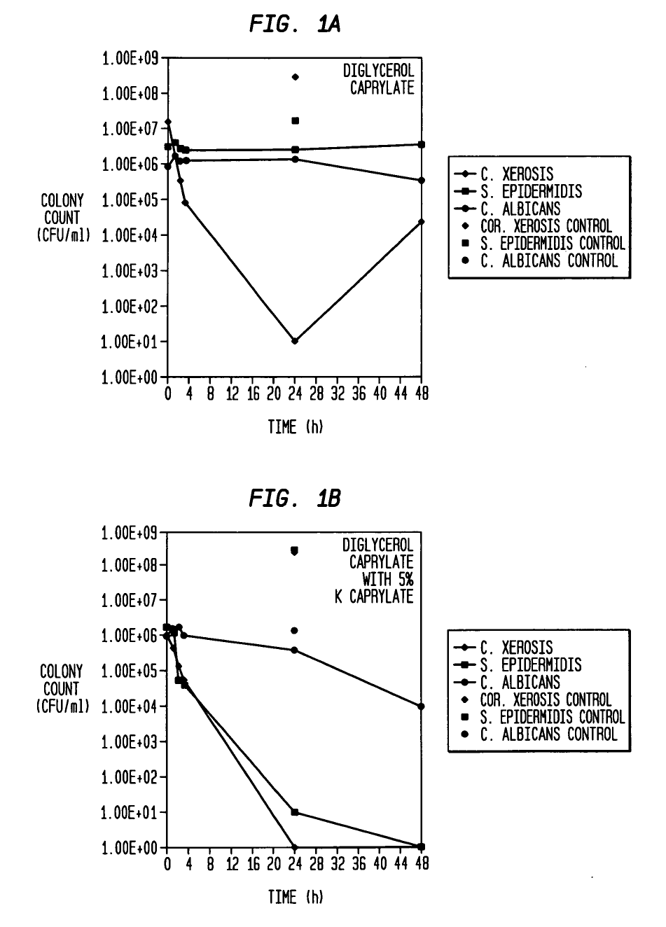

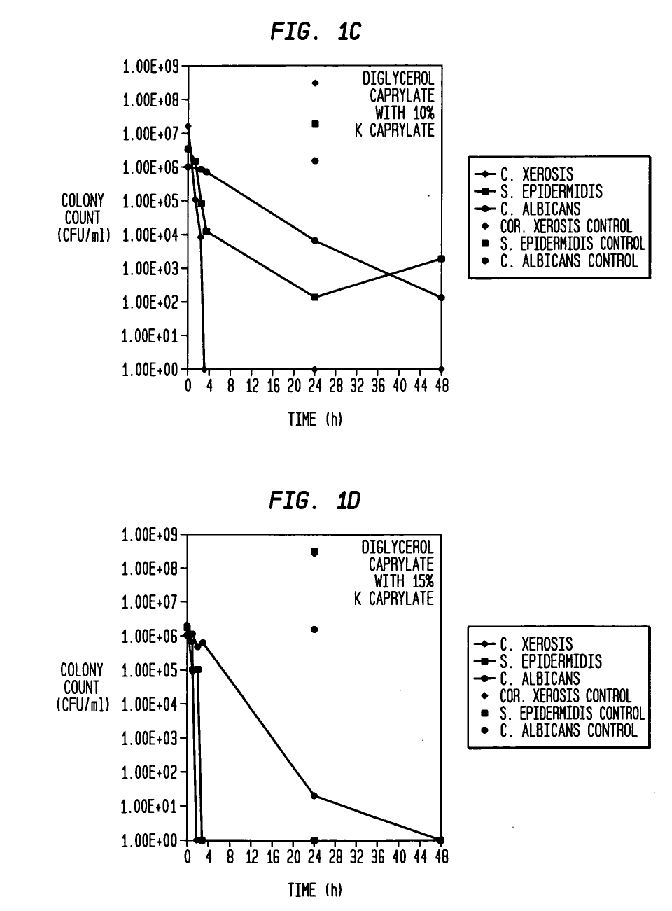

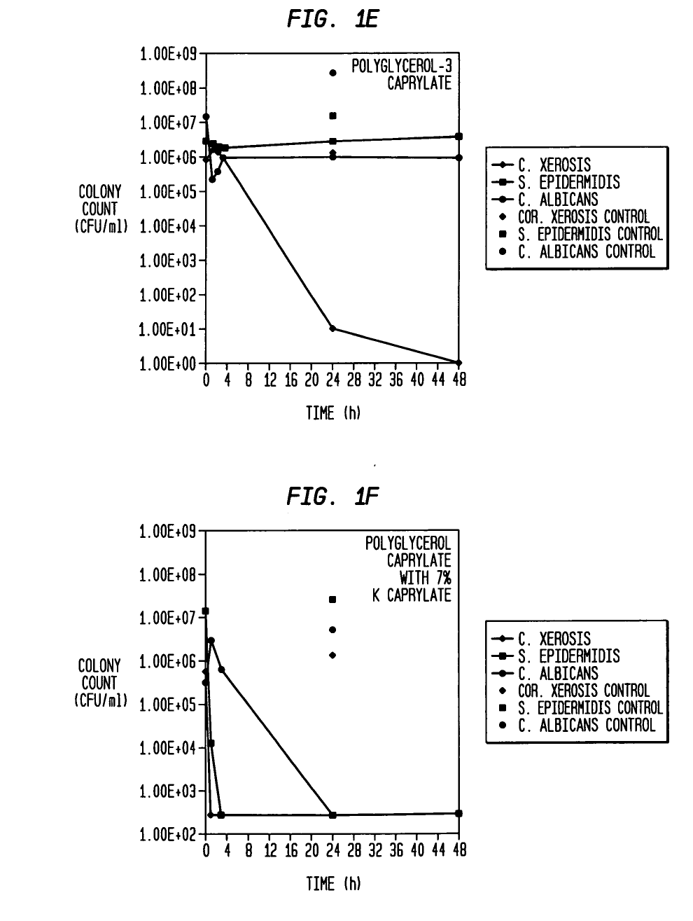

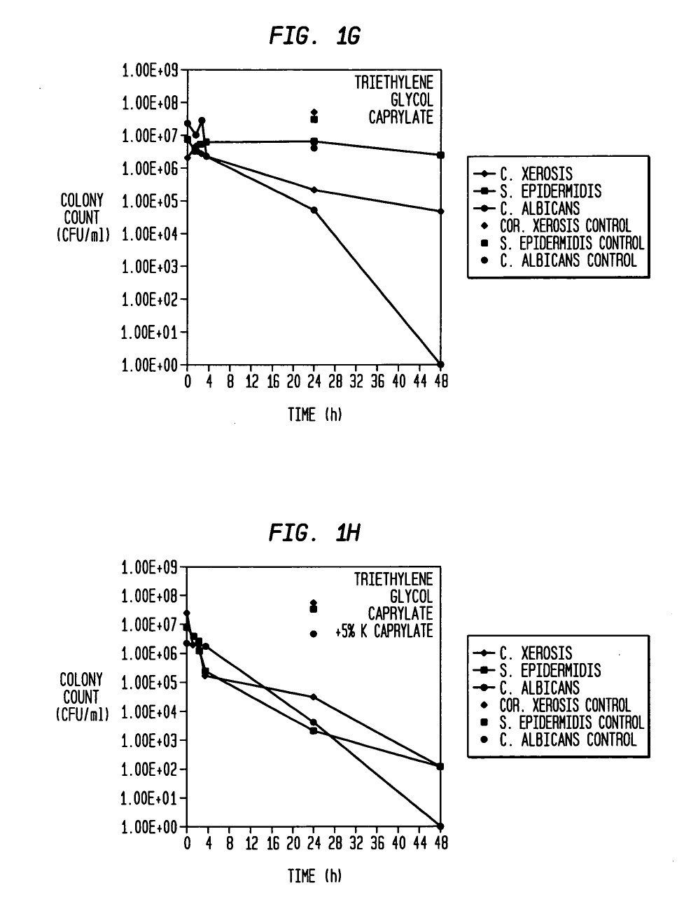

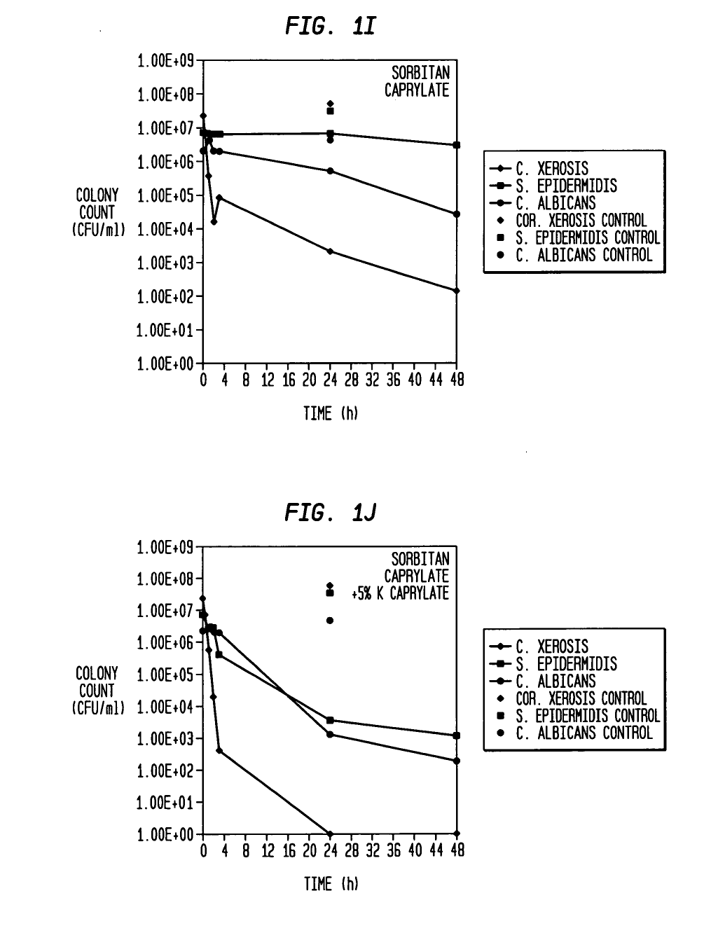

The individual results of the samples are shown in the FIGS. 1A-1J. Also plotted on each of these figures are the microbe populations of an active-ingredient-free blank sample as (isolated) control value after incubation for 24 hours.

B) Against Malassezia Furfur

In the same procedure as described under A, the effectiveness of diglycerol caprylate, comprising 7% potassium caprylate, was tested against M. furfur. M. furfur is causally related to the formation of dandruff.

The mixture according to the present invention was dissolved in water to give a solution containing 3.0% by weight. This solution was treated with microbial suspension, homogenized by shaking and incubated at 30° C. A second solution, without the addition of diglycerol caprylate, was also prepared as a control.

The following results were obtained:

| | Sampling, time (h) | | | | |
|---|---|---|---|---|---|
| | 0 | 1 | 2 | 4 | 24 |
| Control, No. of microbes/ml | 1 × 10⁵ | n.d. | n.d. | n.d. | 1 × 10⁴ |
| 0.3% diglycerol caprylate, | 1 × 10⁵ | <10 | <10 | <10 | <10 |
| No. of microbes/ml | | | | | |

n.d. = not determined

Demonstration of the Cleavability of Polyol Esters by Skin Microbes:

Microorganisms were collected using an underarm swab. For this, a cotton bud dipped into buffer solution (acetate buffer (0.1 M, pH 5.6), comprising 0.1% by weight of Triton X100) was rubbed on the skin in the armpit for about one minute. The cotton bud was then placed in a solution of 2-hydroxy-4-p-nitrophenoxybutyl decanoate. This ester was cleaved in 1.5 h by the enzymes expressed by the skin microbes. The cleavage molecules could be converted easily into p-nitrophenol by oxidation with NaIO₄ and cleaved with BSA; the p-nitrophenol could be quantified by means of UV spectroscopy. Compare D. Lagarde, H. K. Nguyen, G. Ravot, D. Wahler, J.-L. Reymond, G. Hills, T. Veit, F. Lefevre, Org. Process Res. Dev., 6, pp. 441 (2002). Absorbance of varying intensity was observed depending on the person.

| | Arm | Armpit | Forehead | Scalp |
|---|---|---|---|---|
| Person A | 0.116 | 0.624 | 0.321 | 0.157 |
| Person B | 0.063 | 0.267 | 0.186 | 0.389 |
| Person C | 0.077 | 0.185 | 0.108 | 0.082 |
| Person D | 0.091 | 0.260 | 0.293 | 0.157 |
| Person E | 0.057 | 0.047 | 0.164 | 0.164 |

Blank value (average from 4 values): 0.049

Cosmetic Formulations:

Examples of formulations in which the products according to the invention could be used are given below.

Formulation 1:

Deodorant spray (according to the invention)

| | |
|---|---|
| Polyglycerol-3 caprylate, | 0.30% |
| comprising 7% K caprylate (according | |
| to the invention) | |
| Cyclomethicone | 0.75% |
| Ethanol | 38.95% |
| Butane/propane | 60.00% |

The liquid constituents were mixed and the formulation was poured into spray cans under pressure.

Formulation 2:

Deodorant spray (not in accordance with the invention)

| | |
|---|---|
| Triclosan | 0.30% |
| Silicone | 0.75% |
| Ethanol | 38.95% |
| Butane/propane | 60.00% |

The liquid constituents were mixed and the formulation was poured into spray cans under pressure.

Formulation 3:

Clear deodorant pump spray
Phase A:

| | |
|---|---|
| Polyglycerol-3 caprylate, | 0.30% |
| comprising 7% K caprylate (according | |
| to the invention) | |
| Trideceth-12 | 2.00% |
| Dipropylene glycol | 4.00% |
| Perfume | 0.90% |

Phase B:

| | |
|---|---|
| Water | ad 100.00 |
| Preservative | q.s. |
| Citric acid (50% strength) | q.s. |

The constituents specified under phase A were combined with stirring in the order given and then slowly topped up with water (phase B). The pH was adjusted to 5.5 with citric acid.

Formulation 4:

O/W emulsion (sprayable)
Phase A:

| | |
|---|---|
| Glycerol stearate (and) ceteth-20 | 3.00% |
| (e.g. TEGINACID ® H, Degussa) | |
| Stearyl alcohol | 1.00% |
| Polyglycerol-3 caprylate, | 0.30% |
| comprising 7% K caprylate (according | |
| to the invention) | |
| Dimethicone | 0.50% |
| Cetearylethyl hexanoate | 4.00% |
| Caprylic/capric triglyceride | 4.00% |

Phase B:

| | |
|---|---|
| Glycerol | 3.00% |
| Water | ad 100.00% |
| Citric acid (50% strength) | pH = 6 to 7 |
| Preservative | q.s. |
| Perfume | q.s. |

Phases A and B were heated to 70 to 75° C. Phase A was added to phase B with stirring and then homogenized. The mixture was cooled to 30° C. with stirring.

Important:

If phase A is to be introduced initially, phase B must be added without stirring.

Formulation 5:

Clear deodorant roll on
Phase A:

| | |
|---|---|
| Polyglycerol-3 caprylate, | 0.30% |
| comprising 7% K caprylate (according | |
| to the invention) | |
| Trideceth-12 | 2.00% |
| Dipropylene glycol | 2.00% |
| Perfume | 0.50% |
| PEG-14 dimethicone | 1.00% |
| Water | ad 65.00% |

Phase B:

| | |
|---|---|
| Hydroxyethylcellulose (2% in water) | 35.00% |
| Preservative | q.s. |
| Citric acid (50% strength) | q.s. |

The constituents specified under phase A were combined with stirring in the order given. Phase A was added to phase B with stirring. The pH was adjusted to 5.5 with citric acid.

Formulation 6:

Clear deodorant roll on
Phase A:

| | |
|---|---|
| Polyglycerol-3 caprylate, | 0.50% |
| comprising 7% K caprylate (according | |
| to the invention) | |
| Laureth-23 | 2.00% |

Phase B:

| | |
|---|---|
| Perfume | 0.50% |
| PEG-14 dimethicone | 0.50% |
| Alcohol | 20.00% |
| PEG-7 glyceryl cocoate | 1.00% |
| Water | 16.70% |
| Allantoin | 0.20% |
| Panthenol | 0.10% |
| Aluminum chlorohydrate | 20.00% |

Phase C:

| | |
|---|---|
| Hydroxyethylcellulose | 0.75% |
| Water | 36.75% |
| Preservative | q.s. |

Hydroxyethylcellulose was left to swell in water. The preservative was added. The constituents specified under phase A were heated to 50° C. The constituents specified under phase B were added to phase A with stirring. Phase A/B was then stirred into phase C.

Formulation 7:

AP/deodorant stick
Phase A:

| | |
|---|---|
| Stearyl alcohol | 23.00% |
| Hydrogenated castor oil | 4.00% |
| PPG-14 butyl ether | 10.00% |
| Isopropyl palmitate | 16.00% |
| Laureth-4 | 1.00% |

Phase B:

| | |
|---|---|
| Cyclopentasiloxane | 20.00% |

Phase C:

| | |
|---|---|
| Aluminum chlorohydrate | 20.00% |
| Talc | 4.00% |

Phase D:

| | |
|---|---|
| Polyglycerol-3 caprylate, | 1.00% |
| comprising 7% K caprylate (according | |
| to the invention) | |
| Perfume | 1.00% |

The constituents specified under phase A were stirred at 80 to 85° C. until a clear phase was obtained. The constituents specified under phase B were stirred in at about 75° C. The constituents specified under phase C and D were then stirred in.

Formulation 8:

Clear deodorant pump spray
Phase A:

| | |
|---|---|
| Polyglycerol-3 caprylate, | 0.50% |
| comprising 7% K caprylate (according | |
| to the invention) | |
| Laureth-23 | 3.00% |

Phase B:

| | |
|---|---|
| Perfume | 0.50% |
| Bis-PEG/PPG-20/20 dimethicone | 0.50% |
| Water | 94.00% |
| Allantoin | 0.20% |
| Panthenol | 0.10% |
| PEG-7 glyceryl cocoate | 1.00% |
| Trisodium citrate dihydrate | 0.20% |
| Preservative | q.s. |
| Citric acid | q.s. |

The constituents specified under phase A were heated to 50° C. The constituents specified under phase B were added to phase A with stirring in the order given. The pH wass adjusted to 5.5 with citric acid.

Formulation 9:

Anionic household cleaner (concentrate)
Phase A:

| | |
|---|---|
| Polyglycerol-3 caprylate, | 4.00% |
| comprising 7% K caprylate (according | |
| to the invention) | |
| Ethanol | 10.00% |
| Trideceth-12 | 5.00% |
| Cocamidopropylbetaine (˜38% active | 13.20% |
| ingredient content) | |
| Sodium lauryl ether sulfate | 35.80% |

Phase B:

| | |
|---|---|
| Water | ad 100.0% |

The constituents specified under phase A were combined with stirring in the order given and then slowly topped up with water (phase B).

Formulation 10:

| Liquid soap | |
|---|---|
| Sodium laureth sulfate | 25.0% |
| Polyglyceryl-3 caprylate | 0.5% |
| comprising 7% K caprylate (according | |
| to the invention) | |
| PEG-7 glyceryl cocoate | 1.5% |
| Perfume | 0.5% |
| Water | 62.5% |
| Cocamidopropylbetaine | 8.0% |
| PEG-18 glyceryl oleate/cocoate | 2.0% |
| Sodium chloride | q.s. |
| Preservative | q.s. |

All of the components were mixed in the order given.

Formulation 11:

| Toothpaste | |
|---|---|
| Water | 38.25% |
| Sodium benzoate | 0.2% |
| Hydroxyethylcellulose | 1.8% |
| Xylitol | 0.3% |
| Sorbitol (70%) | 12.0% |
| Cocamidopropylbetaine | 2.45% |
| Dimethicone copolyol | 2.0% |
| Polyglyceryl-3 caprylate | 0.5% |
| comprising 7% K caprylate (according | |
| to the invention) | |
| Sodium fluoride | 0.2% |
| Calcium phosphate | 33.0% |
| Silica | 8.0% |
| Titanium dioxide micro | 0.2% |
| PEG-30 glyceryl stearate | 0.5% |
| Aroma oil | 0.6% |

The sodium benzoate was dissolved in water, the hydroxyethylcellulose was added. After this had swollen sufficiently, the other components were incorporated in the order given.

Formulation 12:

| Antidandruff shampoo | |
|---|---|
| Sodium laureth sulfate, 28% | 30% |
| Disodium cocoamphodiacetate | 8.0% |
| Undecylenamidopropylbetaine | 4.0% |
| Polyglyceryl-3 caprylate | 0.5% |
| comprising 7% K caprylate (according | |
| to the invention) | |
| Water | 57.08% |
| Citric acid monohydrate | 0.42% |
| Preservative, perfume | q.s. |

The components were mixed in the order given. The pH was adjusted to about 6 with citric acid.

Cosmetic Application Test:

Two formulations were used. These were formulation 1 and 2. The armpit odor of 20 subjects was tested before and after application of the formulation by three experts. In detail, the test involved the following steps:

1. The armpit was washed with soap, the odor was evaluated by experts.

2. The product was applied once in one armpit. After 6 and 24 h, the odor was tested and the difference was evaluated.

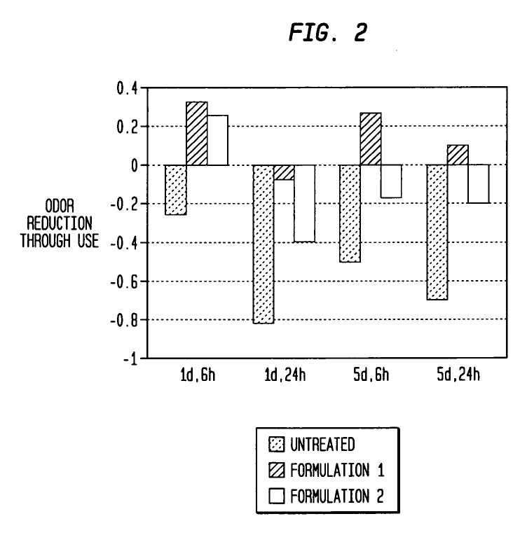

The result of this investigation was that, both after 6 and 24 hours' use, a significant improvement in the odor of the armpit treated in accordance with the invention (formulation 1) was found. An improvement was likewise found compared with the untreated armpit. The armpit treated with the formulation according to the prior art (formulation 2) showed no improvement in odor, only an improvement compared with the untreated armpit. This results are shown, for example, in FIG. 2

Preserving a Food:

Potato salad consisting of 750 g of cooked and finely chopped potatoes, 25 g of finely chopped onions, 1.2 g of cooking salt, 10 ml of vinegar (comprising 6% acetic acid) and 200 g of mayonnaise was treated with 0.5% of the polyglycerol ester from Example 4. To check on bacteria and yeasts, the potato salad was stored for 72 hours at 30° C. Afterwards, the following numbers of microbes were determined:

| | |
|---|---|
| Potato salad without polyglycerol | 1.2 × 10⁶ microbes/ml |
| ester: | |
| Potato salad with polyglycerol | 1.3 × 10³ microbes/ml |
| ester: | |

To check on yeasts and fungi, the potato salad was stored for 72 hours at 25° C. Afterwards, the following numbers of microbes were determined:

| | |
|---|---|
| Potato salad without polyglycerol | 6.7 × 10⁴ microbes/ml |
| ester: | |
| Potato salad with polyglycerol | 2.5 × 10¹ microbes/ml |
| ester: | |

After storage for 96 hours, the potato salad without polyglycerol ester exhibited clearly visible bluish mold, while the potato salad with polyglycerol ester was visually unchanged.

The above embodiments are given to illustrate the scope and spirit of the present invention. These embodiments will make apparent, to those skilled in the art, other embodiments. Those other embodiments are within the contemplation of the present invention. Therefore, the present invention should be limited only by appended claims.

What is claimed is

1. A composition for controlling microorganisms comprising an effective amount of mixtures of fatty acid esters of a polyol and of short-chain monocarboxylic acids, salts of short-chain monocarboxylic acids, or mixtures thereof.

2. The composition of claim 1, which comprises an effective amount of mixtures of fatty acid esters of glycerol/polyglycerol and of short-chain monocarboxylic acids, salts of short-chain monocarboxylic acids, or mixtures thereof.

3. The composition of claim 1, which comprises an effective amount of monoesters and diesters of mono-, di- and/or triglycerol.

4. The composition of claim 1, wherein a ratio of fatty acid esters to monocarboxylic acid salts in the range from 80:20 to 99:1 is employed.

5. The composition of claim 1, wherein the fatty acid esters comprise esterified acids and acid derivatives comprising straight-chain or branched fatty acids having 6 to 14 carbon atoms in the main chain and optionally containing OH groups and/or double bonds.

6. The composition of claim 1, wherein the salts are derived from acids and acid derivatives that comprise straight-chain or branched fatty acids having 3 to 14 carbon atoms in the main chain and optionally containing OH groups and/or double bonds.

7. The composition of claim 1, wherein said composition is as an ingredient of one of a disinfectant, a disinfectant cleaner, a sterilizing composition, an antiseptic, a preservative, a cosmetic formulation, an antimicrobial finishing of a food package or a dental care product.

8. A method comprising applying a composition having an effective amount of mixtures of fatty acid esters of a polyol and of short-chain monocarboxylic acids, salts of short-chain monocarboxylic acids, or mixtures thereof to a surface containing at least one of Gram-positive bacteria, Gram-negative bacteria, mycobacteria, dermatophytes, yeast and hyphal fungi, viruses or spores.
